(19) United States
(12) Patent Application Publication
(10) Pub. No.: US 2026/0197418 A1
(43) Pub. Date: Jul. 9, 2026

(54) WEB CONFERENCE POPUPS FOR VAGUE PHRASES

(71) Applicant: International Business Machines Corporation, Armonk, NY (US)

(72) Inventors: Guang Han SUI, Beijing (CN); Peng Hui JIANG, Beijing (CN); Su LIU, Austin, TX (US); Jun SU, Beijing (CN)

(21) Appl. No.: 19/013,079

(22) Filed: Jan. 8, 2025

(51) Int. Cl. H04N 7/15; G06F 40/30

(52) U.S. Cl. CPC H04N 7/15; G06F 40/30

(57) ABSTRACT

Embodiments herein describe displaying popups in web conferences for vague phrase that may have multiple definitions or meanings. To select the correct definition or meaning, the system can determine or monitor a context of the web conference. In one embodiment, the system uses the context to index into a dictionary to select one of the definitions for phrases that have multiple definitions. A popup with the selected definition can then be displayed in the web conference.

### BACKGROUND

Web conferencing software facilitates communication between individuals online via transmission of audio/video (A/V) data of the individuals in real-time over a network.

### SUMMARY

According to one embodiment of the present invention, a method includes identifying a context of a web conference from speech spoken in the web conference; detecting that a phrase spoken in the web conference is in a dictionary where the dictionary comprises a plurality of entries each of the plurality of entries comprising (i) a respective phrase, (ii) multiple definitions of the respective phrase, and (iii) a respective context for each of the multiple definitions; selecting one of the multiple definitions of the phrase from a corresponding entry in the dictionary using the context; and displaying the selected definition in a popup in a graphical user interface (GUI) of the web conference.

According to one embodiment of the present invention, a system that includes one or more memories; and one or more processors communicatively coupled to the one or more memories, the one or more processors configured to, individually or collectively, perform operations. These operations includes identifying a context of a web conference from speech spoken in the web conference; detecting that a phrase spoken in the web conference is in a dictionary where the dictionary comprises a plurality of entries each of the plurality of entries comprising (i) a respective phrase, (ii) multiple definitions of the respective phrase, and (iii) a respective context for each of the multiple definitions; selecting one of the multiple definitions of the phrase from a corresponding entry in the dictionary using the context; and displaying the selected definition in a popup in a graphical user interface (GUI) of the web conference.

According to one embodiment of the present invention, a computer program product, the computer program product including a computer-readable storage medium having computer-readable program code embodied therewith, the computer-readable program code executable by one or more computer processors to perform operations. These operations includes identifying a context of a web conference from speech spoken in the web conference; detecting that a phrase spoken in the web conference is in a dictionary where the dictionary comprises a plurality of entries each of the plurality of entries comprising (i) a respective phrase, (ii) multiple definitions of the respective phrase, and (iii) a respective context for each of the multiple definitions; selecting one of the multiple definitions of the phrase from a corresponding entry in the dictionary using the context; and displaying the selected definition in a popup in a graphical user interface (GUI) of the web conference.

### BRIEF DESCRIPTION OF THE DRAWINGS

FIG. 1 illustrates a computing system, according to one embodiment.

FIG. 2 illustrates a computing system for providing popups in a web conference for vague terms, according to one embodiment.

FIG. 3 is a flowchart for displaying a definition of a vague term using the context of the web conference, according to one embodiment.

FIG. 4 illustrates a popup of a vague term in a web conference, according to one embodiment.

FIG. 5 illustrates a popup of a vague term in a web conference, according to one embodiment.

FIG. 6 is a flowchart for identifying a definition of a vague term using the context of the web conference, according to one embodiment.

FIG. 7 illustrates a popup of a vague term in a web conference, according to one embodiment.

### DETAILED DESCRIPTION

Buzzwords, acronyms, and abbreviations are often used during web conferences. Moreover, these phrases can have multiple meanings. For example, “IP” can mean Intellectual Property or Internet Protocol. A participant in the web conference may have to take their attention away from the web conference to perform a web search in order to determine the meaning of a vague phrase. Even then, the web search may provide a definition of the phrase (which can have multiple definitions) that is different from the way the phrase is currently being used in the web conference.

Embodiments herein describe displaying popups in web conferences for vague phrase that may have multiple definitions or meanings. To select the correct definition or meaning, the system can determine or monitor a context of the web conference. For example, a socket may mean an electrical component used to connect an appliance to power when the context of the web conference is about power or electricity, but a socket may mean a network interface when the context of the web conference is about computer networks. In one embodiment, the system uses the context to index into a pre-populated dictionary to select one of the definitions for phrases that have multiple definitions. A popup with the selected definition can then be displayed in the web conference. Having a pre-populated dictionary can improve the performance of the computer system executing the teleconference application by saving power and compute resources. Without the techniques described herein, a user may have to open a separate web browser or other search application and attempt to find the definition of the vague phrase on her own. Doing so will use significantly more power and compute resource relative to the techniques described herein where a pre-populated dictionary is used to provide definitions of vague phrases. Moreover, the web browser or search application will compete for compute resources with the teleconference application, which may degrade the performance of the teleconference application. Instead, with a pre-populated dictionary, the teleconference application can provide definitions of vague phrases to the user using much less compute resources. As such, the computing system can provide more compute resources to the teleconference application, which can require large amounts of memory and processing power.

The descriptions of the various embodiments of the present invention are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as phase identifier 200 which can provide popups with definitions of vague phrases used in a web conference. In addition to phrase identifier 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and phrase identifier 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

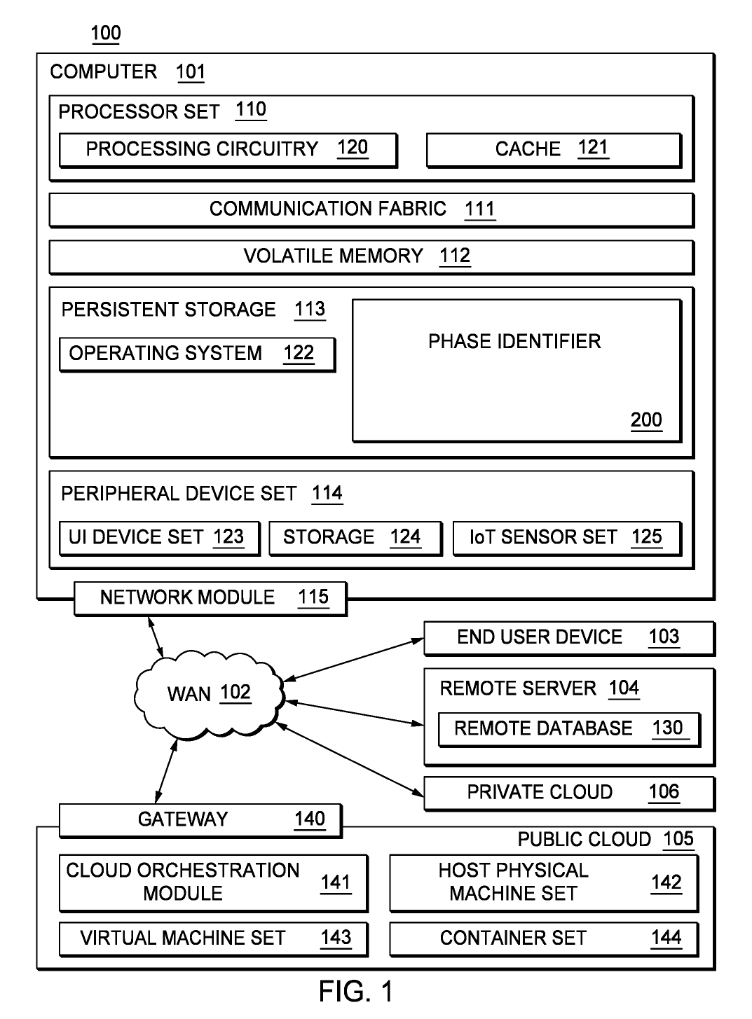

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in phrase identifier 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in phrase identifier 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

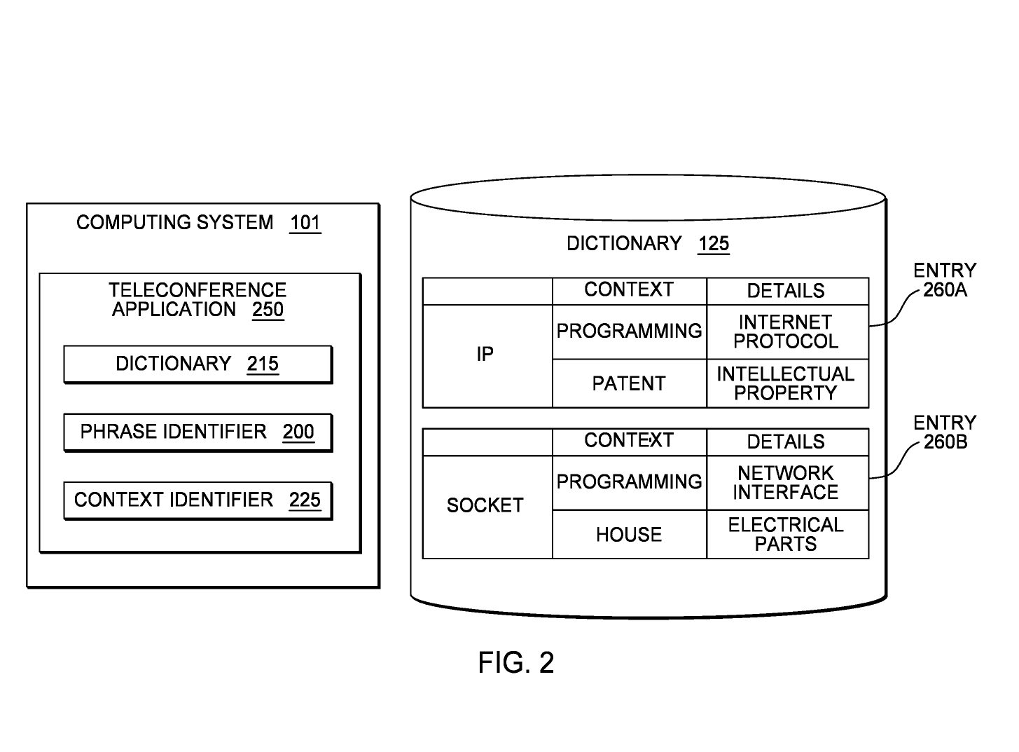

FIG. 2 illustrates a computing system for providing popups in a web conference for vague terms, according to one embodiment. FIG. 2 illustrates that the computer 101 described in FIG. 1 can be used to execute a teleconference application 250 which can establish web conferences where users can use computing devices (e.g., desktops, laptops, tablets, smartphones, etc.) to hear and see each other (or see a visual presentation).

The teleconference application 250 includes a dictionary 215, a phrase identifier 200, and a context identifier 225. The right side of FIG. 2 illustrates one example of a dictionary 215 for storing multiple definitions of vague phrases. In one embodiment, the dictionary 215 includes entries 260 for phrases that have multiple definitions depending on a context in which the phrase is used. In this example, the dictionary 215 includes then entry 260A for the vague phrase IP which can mean “internet protocol” when the context is programming but “intellectual property” when the context is patents. The dictionary 215 also includes then entry 260B for the vague phrase socket which can be a network interface when the context is programming but be an electrical part when the context is house construction.

The vague phrases can be acronyms, abbreviations, or a word with multiple meanings. However, the dictionary 215 can also store words with only one meaning or definition, but in that case the context would not be needed in those entries 260.

In one embodiment, the dictionary 215 is populated with vague phrases and their meaning before a web conference is initiated. That way, the dictionary 215 can be referenced whenever a vague phrase is used in the web conference. As discussed above, this has the technical advantage of being able to provide a user with definitions of vague terms without the user having to open a search application to identify the definition on her own, which means there are less compute resources for the teleconference application 250 which can degrade its performance.

The phrase identifier 200 can monitor the speech (or a transcript) in the web conference to determine if someone in the web conference spoke a phrase stored in one of the entries 260 in the dictionary 215. A context identifier 225 can also monitor the speech (or transcript) to determine a context associated with the web conference (whether the people are discussing programming, network troubleshooting, filing patents, construction, etc.). The context identifier 225 could use any suitable technique for processing the speech in the web conference to identify the context, such as a large language model (LLM).

Using the context, the phrase identifier 200 can select the most appropriate definition of the vague term from the dictionary 215. That is, the phrase identifier 200 can parse the dictionary 215 to identify the entry 260 corresponding to the phrase and then use the context to identify which of the definitions is correct for the current web conference. The phrase identifier 200 can then output a popup in a graphical user interface (GUI) of the web conference with the definition of the phrase. In one embodiment, the phrase identifier 200 can perform these functions in near real-time. The phrase identifier 200 can constantly monitor the speech in the web conference, and once a phrase in the dictionary 215 is spoken, use the context of the meeting to generate a popup with the definition. This enables a potentially confused user to see the definition of a vague phrase almost immediately, thereby permitting her to focus on the meeting without having to go to a different source to identify the meaning of a vague phrase (or simply remain confused as the meeting continues).

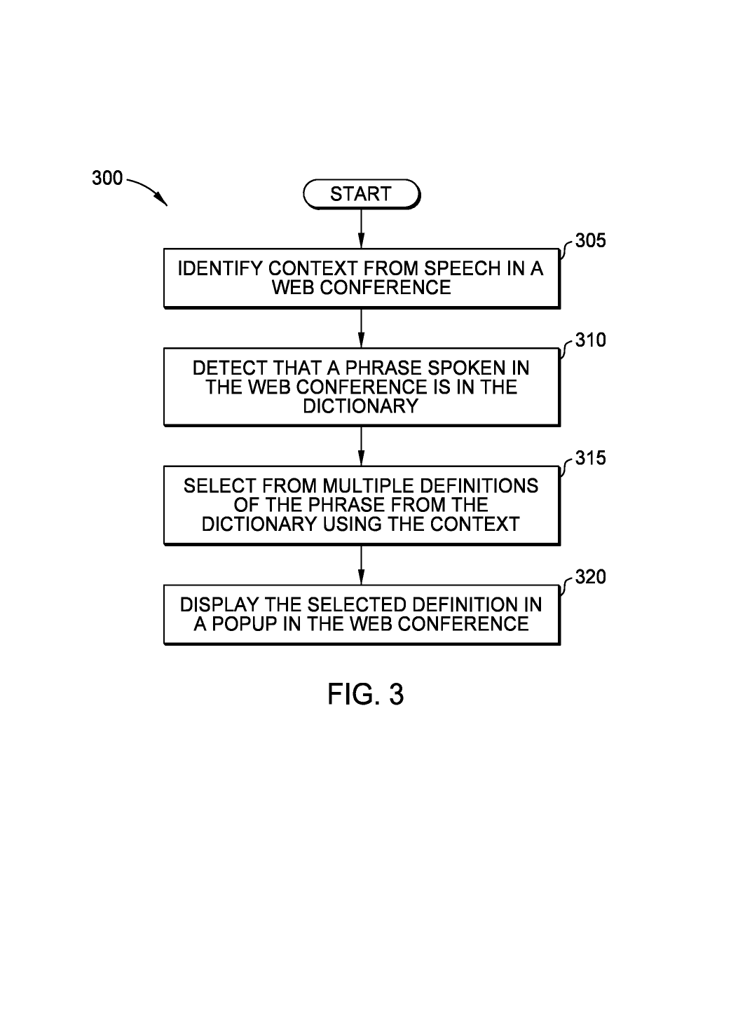

FIG. 3 is a flowchart of a method 300 for displaying a definition of a vague term using the context of the web conference, according to one embodiment. At block 305, the context identifier (e.g., the context identifier 225 in FIG. 2) identifies a context of a web conference using speech in the web conference. The context can be a main topic (or topics) of the web conference, the subject of a sentence (e.g., each sentence can have a context), and the like. Moreover, the context may changes as the speech changes. For example, at one point of time, the meeting participants may discuss solutions to a customer’s network problems but then later discuss filing a patent on their solution. There, the context may first be network troubleshoot but then switch to patent issues.

At block 310, the phrase identifier (e.g., the phrase identifier 200 in FIGS. 1 and 2) detects a phrase from the dictionary being spoken in the web conference. In one embodiment, the phrase identifier can constantly monitor the speech (or a transcript) of the meeting and search in the dictionary to determine whether there are entries for those phrases in the dictionary. For example, the phrase identifier can, in real-time, search the dictionary as new phrases are spoken in the meeting. This ensures that computing system can provide definitions of vague phrase (as discussed in the remaining blocks of method 300) as soon as possible so the participant can following along with the web conference without being confused by a vague phrase.

In one embodiment, the dictionary is pre-populated (e.g., before the web conference began) with entries for multiple various phrase which may be vague. The dictionary can be populated by a user, or by an algorithm the identifies phrases with multiple meanings.

At block 315, the phrase identifier selects from multiple definitions of the phrase from the dictionary using the context. As shown in FIG. 2, each definition of a vague phrase corresponds to a different context. As such, the phrase identifier can use the context (which was identified at block 305) to select the appropriate definition of the vague phrase.

While the method 300 illustrates identifying the context before a vague phrase is identifier at block 310, the reverse may be true where the phrase identifier first identifies a phrase being spoken that is in the dictionary and then the context identifier identifiers a context. However, since it may take more time to identifier the current context of a meeting, it may improve responsiveness if the context identifier is continually identifying the context so it is ready when the phase identifier identifies a vague phrase.

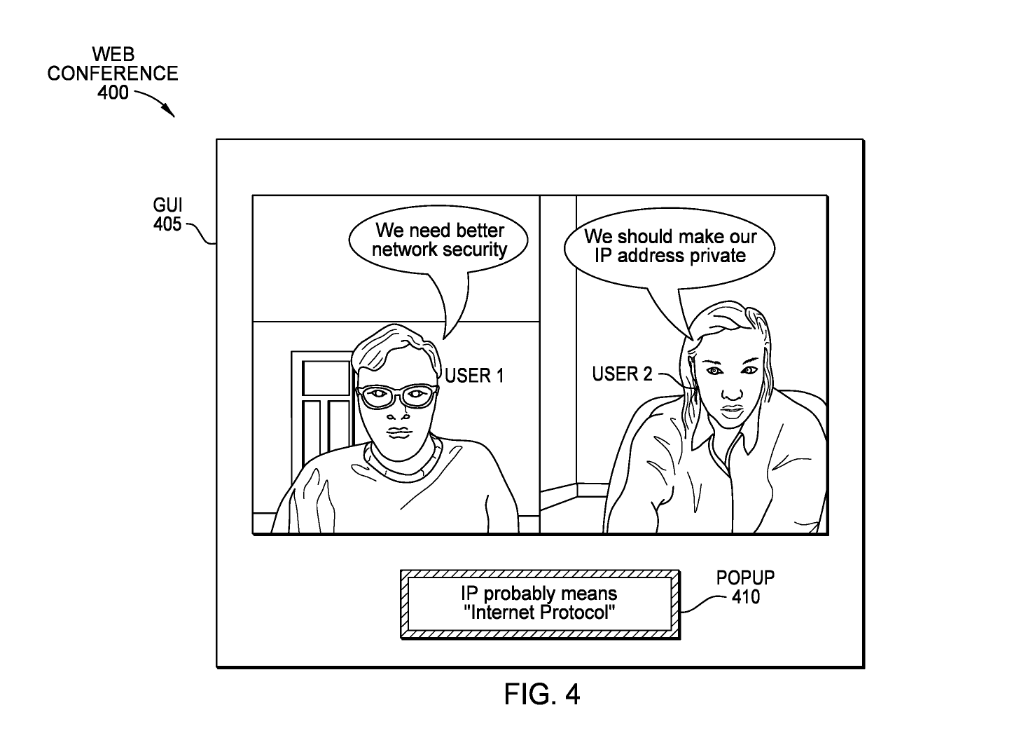

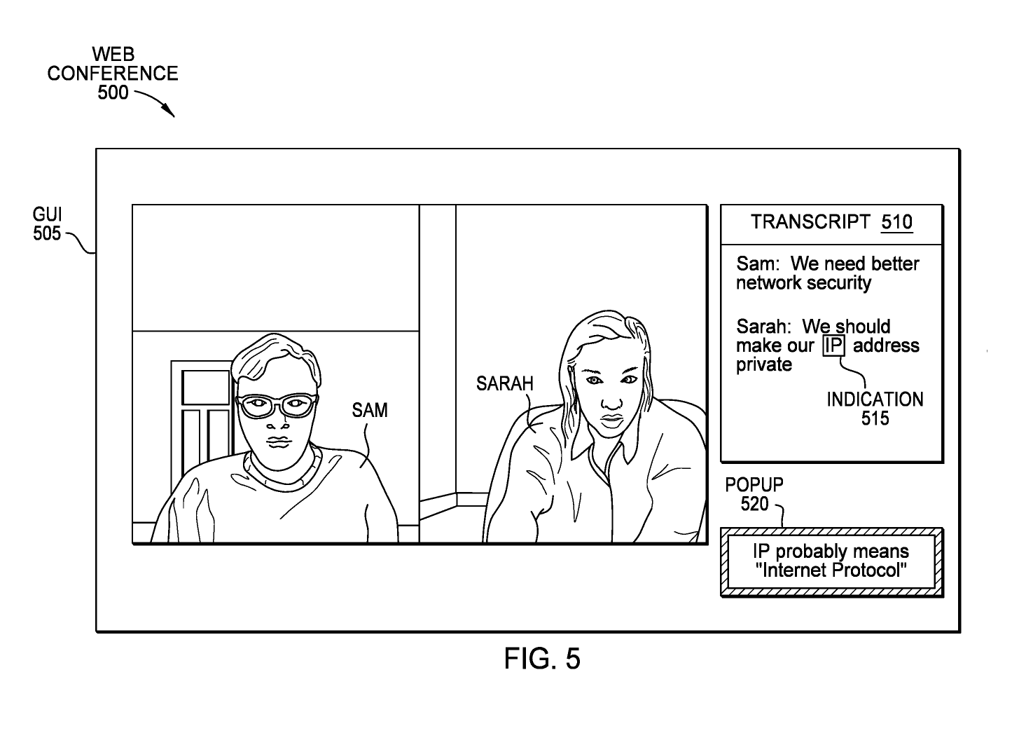

At block 320, the phase identifier displays the selected definition in a popup in the web conference. Several embodiments of this are illustrated in FIGS. 4 and 5.

FIG. 4 illustrates a popup 410 of a vague term in a web conference 400, according to one embodiment. The web conference 400 can be a meeting held by using a teleconference communication. While web conference 400 illustrates displaying users in a GUI 405, the embodiments herein can also be used if the GUI 405 is displaying a presentation, picture, or any other graphical object.

The GUI 405 includes text boxes that illustrate what the two displayed user are saying, but these text boxes are just for illustration and instead can represent audio that the user viewing the GUI 405 hears as the other participants are speaking. Here, User 1 says “we need better network security” while User 2 says “we should make our IP address private.” The phrase identifier can detect that “IP” was spoken in the web conference 400 either by processing the audio or processing a transcript of the web conference. In addition, the context identifier can process the audio or transcript to identify the context of the meeting. Because the users are discussing network security, the context identifier can select the context are networks or programming. The phrase identifier can use the context to select the most appropriate definition of the vague phrase (i.e., IP) to display in the popup 410. In this manner, the teleconference application can automatically (e.g., without user input) provide real-time definitions of vague phrases to participants in the web conference 400 using popups 410.

Also, the GUI 405 can provide accents or highlights (e.g., a bright yellow color or flashing colors) around the popups 410 to attract the participant’s attention to the popup 410. The teleconference application may also determine which user in the web conference spoke the vague phase and provide the popup 410 nearer to that user (e.g., near to User 2 than User 1) since that is the most likely place where the participant is currently staring. That may make it easier for the participant to read the popup 410 and remain focused on the web conference 400.

FIG. 5 illustrates a popup 520 of a vague term in a web conference 500, according to one embodiment. Here, the teleconference application generates a transcript 510 of the speech of the users. In this embodiment, rather than the phrase identifier automatically displaying the definition of a vague phrase (based on the context of the web conference 500), the phrase identifier can mark a vague phrase in the transcript 510 using a graphical indication 515. For example, the phrase identifier may highlight the text of the vague phrase so it is different from other text in the transcript 510, or draw a box around the phrase.

The graphical indication 515 indicates to the participant that the phrase identifier is ready to provide a definition of the indicated phrase (“IP). However, the participant may have to perform an action such as clicking on the phrase or touching the phrase (if the GUI 505 is displayed on a touch enabled display device). If the user performs the action, the phase identifier displays the popup 520 on the GUI 505.

FIG. 5 advantageously gives the meeting participant control whether the popup 520 containing the definition is displayed. For example, the participant may not be confused by the phrase. The participant may have already known the definition of the phrase, and thus, not need help form the teleconference application. This reduces the number of popups and can help the participant to better focus on the web conference 500. For instance, the teleconference application can offer the participant the option on whether to automatically provide the popups, or whether to display a transcript 510 which gives the user the option to select which phrases should have their definitions displayed in popups.

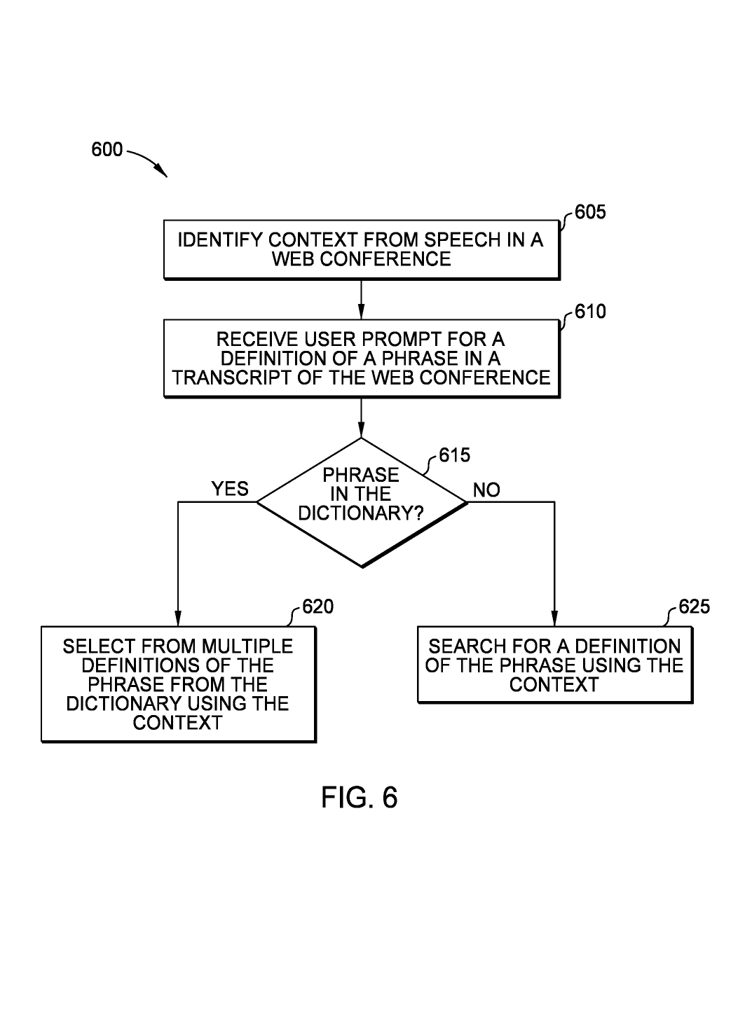

FIG. 6 is a flowchart of a method 600 for identifying a definition of a vague term using the context of the web conference, according to one embodiment. In method 600, a participant in a web conference can hear a phrase that she does not know, and the phrase may not be in the dictionary. As such, the phrase identifier may be unable to immediately provide the definition of the phrase. In that case, the method 600 can be used to provide the participant with the correct definition of the phrase.

At block 605, the context identifier identifies context from speech in the web conference. This can be the same as block 305 in FIG. 3.

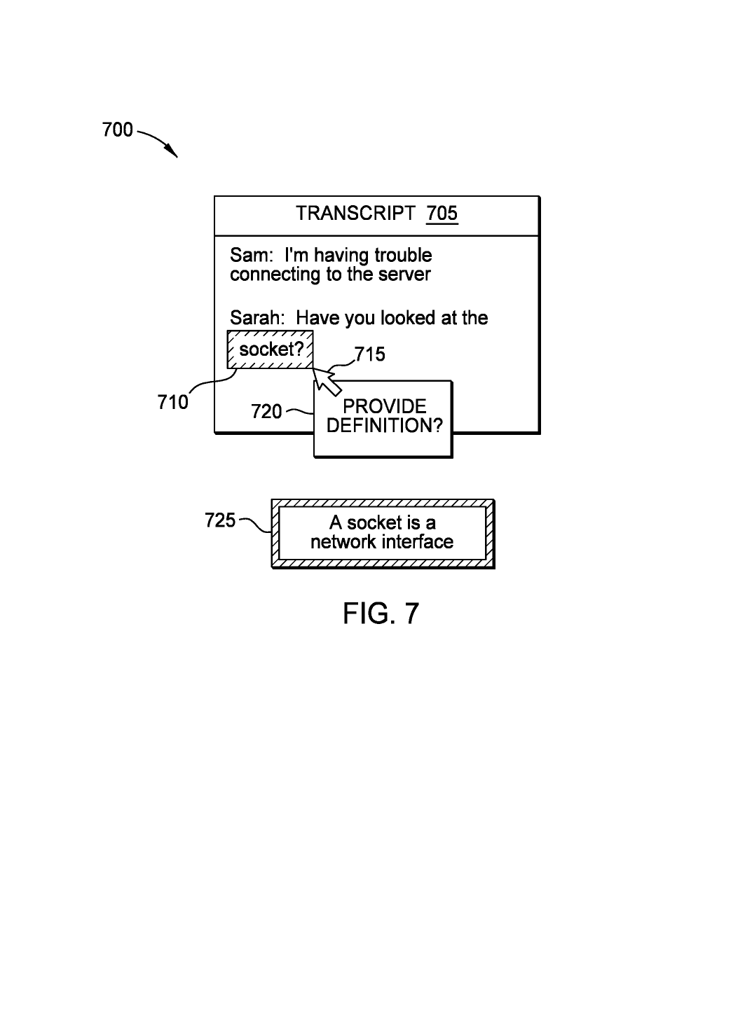

At block 610, the teleconference application receives a user prompt for a definition of a phrase in a transcript of the web conference. To illustrate this, reference is made to FIG. 7 which shows a transcript 705 that is displayed in a web conference 700. In this example, the participant does not know the meaning of socket. However, it is assumed that this vague phrase is not in the dictionary, as such, the phrase identifier may not have automatically displayed the definition of the phrase (as done in FIG. 4) or marked the phrase using an indication (as done in FIG. 5).

Instead, the user can highlight 710 the text using a cursor 715 (or a finger or stylus if the web conference is displayed on a touch-enabled display). This may trigger the teleconference application to display a prompt 720 that asks whether the user wants the teleconference application to attempt to provide a definition of the highlighted phrase.

Returning to the method 600, at block 615 the phrase identifier determines whether the phrase highlighted by the user is in the dictionary. In this embodiment, the phrase identifier may not continually monitor the speech in the web conference to determine if a phrase is the dictionary (which may save compute resources at the cost of providing real-time definitions). However, in other embodiments, the phrase identifier may have already done a search of the dictionary (because it monitors the speech in real-time) and know the phrase is not in the dictionary.

If the phrase is not in the dictionary, the method 600 proceeds to block 620 where the phrase identifier performs a search for the definition of the phrase. This search can include a web search or submitting a query to a LLM. In addition, because the phrase may be vague because it has multiple definitions, the phrase identifier may provide the context when submitting the web search of the query to the LLM. This can improve the accuracy of the search result so the phrase identifier can provide the correct corresponding definition. Once the definition is identified, the phase identifier can provide the definition in a popup such as the popup 725 illustrated in FIG. 7.

Also, by submitting the search through the phrase identifier (which is part of the teleconference application), this can use much fewer compute resources (and be faster) than a user having to open a web browser or a separate LLM application programming interface (API) to attempt to identify the definition of the phrase.

However, if the phrase is in the dictionary, the method 600 instead proceeds to block 620 where the phrase identifier selects from multiple definitions of the phrase from the dictionary using the context. This can be the same as discussed at block 315 of FIG. 3.

While the foregoing is directed to embodiments of the present invention, other and further embodiments of the invention may be devised without departing from the basic scope thereof, and the scope thereof is determined by the claims that follow.

What is claimed is:

1. A method comprising:
identifying a context of a web conference from speech spoken in the web conference;
detecting that a phrase spoken in the web conference is in a dictionary, wherein the dictionary comprises a plurality of entries, each of the plurality of entries comprising (i) a respective phrase, (ii) multiple definitions of the respective phrase, and (iii) a respective context for each of the multiple definitions;
selecting one of the multiple definitions of the phrase from a corresponding entry in the dictionary using the context; and
displaying the selected definition in a popup in a graphical user interface (GUI) of the web conference.

2. The method of claim 1, wherein the identifying, detecting, selecting, and displaying steps are performed automatically in real-time and without user input.

3. The method of claim 1, wherein the identifying, detecting, and selecting steps are performed automatically in real-time and without user input.

4. The method of claim 3, further comprising, before displaying the selected definition:
displaying a transcript of the speech spoken in the web conference in the GUI of the web conference, wherein the phrase is in the transcript and a graphical indication is displayed with the phrase to indicate to a participant in the web conference that the phrase is in the dictionary.

5. The method of claim 4, further comprising:
detecting a user action indicating the user wants to see the selected definition, and in response, the selected definition is displayed in the popup.

6. The method of claim 1, further comprising:
displaying a transcript of the speech spoken in the web conference in the GUI of the web conference;
receiving a user prompt for a definition of a second phrase in the transcript;
determining that the second phrase is not in the dictionary; and
searching for a definition of the second phrase using the context.

7. The method of claim 6, further comprising:
displaying the definition of the second phrase in a second popup in the web conference.

8. The method of claim 7, wherein searching for the definition of the second phrase is performed using a web search or submitting a query to a large language model (LLM).

9. A system, comprising:
one or more memories; and
one or more processors communicatively coupled to the one or more memories, the one or more processors configured to, individually or collectively, perform operations comprising:
identifying a context of a web conference from speech spoken in the web conference;
detecting that a phrase spoken in the web conference is in a dictionary, wherein the dictionary comprises a plurality of entries, each of the plurality of entries comprising (i) a respective phrase, (ii) multiple definitions of the respective phrase, and (iii) a respective context for each of the multiple definitions;
selecting one of the multiple definitions of the phrase from a corresponding entry in the dictionary using the context; and
displaying the selected definition in a popup in a graphical user interface (GUI) of the web conference.

10. The system of claim 9, wherein the identifying, detecting, selecting, and displaying steps are performed automatically in real-time and without user input.

11. The system of claim 9, wherein the identifying, detecting, and selecting steps are performed automatically in real-time and without user input.

12. The system of claim 11, wherein the operations further comprising, before displaying the selected definition:
displaying a transcript of the speech spoken in the web conference in the GUI of the web conference, wherein the phrase is in the transcript and a graphical indication is displayed with the phrase to indicate to a participant in the web conference that the phrase is in the dictionary.

13. The system of claim 12, wherein the operations further comprising:
detecting a user action indicating the user wants to see the selected definition, and in response, the selected definition is displayed in the popup.

14. The system of claim 9, wherein the operations further comprising:
displaying a transcript of the speech spoken in the web conference in the GUI of the web conference;
receiving a user prompt for a definition of a second phrase in the transcript;
determining that the second phrase is not in the dictionary; and
searching for a definition of the second phrase using the context.

15. The system of claim 14, wherein the operations further comprising:
displaying the definition of the second phrase in a second popup in the web conference, wherein searching for the definition of the second phrase is performed using a web search or submitting a query to a large language model (LLM).

16. A computer program product, the computer program product comprising:
a computer-readable storage medium having computer-readable program code embodied therewith, the computer-readable program code executable by one or more computer processors to perform operations, the operations comprising:
identifying a context of a web conference from speech spoken in the web conference;
detecting that a phrase spoken in the web conference is in a dictionary, wherein the dictionary comprises a plurality of entries, each of the plurality of entries comprising (i) a respective phrase, (ii) multiple definitions of the respective phrase, and (iii) a respective context for each of the multiple definitions;
selecting one of the multiple definitions of the phrase from a corresponding entry in the dictionary using the context; and
displaying the selected definition in a popup in a graphical user interface (GUI) of the web conference.

17. The computer program product of claim 16, wherein the identifying, detecting, selecting, and displaying steps are performed automatically in real-time and without user input.

18. The computer program product of claim 16, wherein the identifying, detecting, and selecting steps are performed automatically in real-time and without user input.

19. The computer program product of claim 18, wherein the operations further comprising, before displaying the selected definition:
displaying a transcript of the speech spoken in the web conference in the GUI of the web conference, wherein the phrase is in the transcript and a graphical indication is displayed with the phrase to indicate to a participant in the web conference that the phrase is in the dictionary.

20. The computer program product of claim 19, wherein the operations further comprising:
detecting a user action indicating the user wants to see the selected definition, and in response, the selected definition is displayed in the popup.
